(19) United States
(12) Patent Application Publication
(10) Pub. No.: US 2014/0177305 A1
(43) Pub. Date: Jun. 26, 2014

(54) GATE DRIVE CIRCUIT FOR SYNCHRONOUS RECTIFICATION

(71) Applicant: QUALCOMM Incorporated, San Diego, CA (US)

(72) Inventor: Linda S. Irish, San Diego, CA (US)

(21) Appl. No.: 13/919,885

(22) Filed: Jun. 17, 2013

Related U.S. Application Data
(60) Provisional application No. 61/740,722, filed on Dec. 21, 2012.

(51) Int. Cl. H02M 7/217

(52) U.S. Cl. CPC H02M 7/217
USPC 363/127

(57) ABSTRACT

Systems, methods and apparatus are disclosed for AC to DC conversion. In one aspect a rectifier circuit for providing DC voltage to a load based at least in part on an AC input from an AC output source having a first and second terminal is provided. The rectifier circuit includes a first transistor and a second transistor, each transistor having a first terminal, a second terminal, and a control terminal. The second transistor is configured to limit a voltage applied to the control terminal of the first transistor. The control terminal of the second transistor is coupled to a voltage source applying a control voltage to the control terminal. The control terminal of the first transistor is coupled to the first terminal of the second transistor. The first and second transistors have their second terminals respectively connected to the second and first terminals of the AC output source.

### CLAIM OF PRIORITY UNDER 35 U.S.C. §119

This application claims priority under 35 U.S.C. §119(e) to: U.S. Provisional Patent Application 61/740,722 entitled “GATE DRIVE CIRCUIT FOR SYNCHRONOUS RECTIFICATION” filed on Dec. 21, 2012, the disclosure of which is hereby incorporated by reference in its entirety.

### FIELD

The present disclosure relates generally to a synchronous rectifier that may be used in a wireless power receiver. More specifically, the disclosure is directed to a gate drive circuit for a synchronous rectifier.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections through cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices or provide power to electronic devices may overcome some of the deficiencies of wired charging solutions. As such, wireless power transfer systems and methods that efficiently and safely transfer power to electronic devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the subject matter described in the disclosure provides a rectifier circuit for providing direct current (DC) voltage to a load based on at least in part on an alternating current (AC) input from an AC output source having a first and second terminal. The circuit includes a first transistor having a first terminal, a second terminal, and a control terminal. The second terminal of the first transistor is coupled to the second terminal of the AC output source. The circuit further includes a second transistor having a first terminal, a second terminal, and a control terminal. The second terminal of the second transistor is coupled to the first terminal of the AC output source. The control terminal of the first transistor is coupled to the first terminal of the second transistor. The control terminal of the second transistor is coupled to a voltage source. The second transistor is configured to limit a voltage applied to the control terminal of the first transistor.

Another aspect of the subject matter described in the disclosure provides an implementation of a method for providing direct current (DC) based at least in part on an alternating current from an AC output source. The method includes rectifying the alternating current to the direct current at least in part via a first transistor having a control terminal. The method also includes applying a control voltage with a voltage source to a second transistor having a control terminal. The method further includes limiting an amount of voltage applied to the control terminal of the first transistor via a second transistor.

Yet another aspect of the subject matter described in the disclosure provides an apparatus for providing direct current (DC) based at least in part on an alternating current from an AC output source. The apparatus includes means for selectively causing current to flow in response to a control voltage. The apparatus further includes means for limiting an amount of the control voltage of the means for selectively causing current to flow. The means for limiting an amount of the control voltage comprises means for selectively providing an open circuit. The means for selectively providing an open circuit comprises a means for providing voltage.

### BRIEF DESCRIPTION OF THE DRAWINGS

FIG. 1 is a functional block diagram of an exemplary wireless power transfer system, in accordance with exemplary embodiments of the invention.

FIG. 2 is a functional block diagram of exemplary components that may be used in the wireless power transfer system of FIG. 1, in accordance with various exemplary embodiments of the invention.

FIG. 3 is a schematic diagram of a portion of transmit circuitry or receive circuitry of FIG. 2, including a transmit or receive antenna, in accordance with exemplary embodiments of the invention.

FIG. 4 is a functional block diagram of a transmitter that may be used in the wireless power transfer system of FIG. 1, in accordance with exemplary embodiments of the invention.

FIG. 5 is a functional block diagram of a receiver that may be used in the wireless power transfer system of FIG. 1, in accordance with exemplary embodiments of the invention.

FIG. 6 is a schematic diagram of an exemplary full bridge rectifier circuit.

FIG. 7 is a schematic diagram of an exemplary self-driven synchronous rectifier circuit.

FIG. 8 is another schematic diagram of an exemplary self-driven synchronous rectifier circuit, in accordance with exemplary embodiments of the invention.

FIG. 9 is yet another schematic diagram of an exemplary self-driven synchronous rectifier circuit, in accordance with an exemplary embodiment of the invention.

FIG. 10 is yet another schematic diagram of an exemplary self-driven synchronous rectifier circuit, in accordance with an exemplary embodiment of the invention.

FIG. 11 is a plot showing exemplary voltage waveforms of the self-driven synchronous rectifier circuit of FIG. 10.

FIG. 12 is a flow chart of an exemplary method for providing direct current (DC) based at least in part on an alternating current from an AC output source, in accordance with an exemplary embodiment of the invention.

FIG. 13 is a functional block diagram of an apparatus for providing direct current (DC) based at least in part on an alternating current from an AC output source, in accordance with an exemplary embodiment of the invention.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving antenna” to achieve power transfer.

FIG. 1 is a functional block diagram of an exemplary wireless power transfer system 100, in accordance with exemplary embodiments of the invention. Input power 102 may be provided to a transmitter 104 from a power source (not shown) for generating a field 105 for providing energy transfer. A receiver 108 may couple to the field 105 and generate output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship. When the resonant frequency of receiver 108 and the resonant frequency of transmitter 104 are substantially the same or very close, transmission losses between the transmitter 104 and the receiver 108 are minimal. As such, wireless power transfer may be provided over larger distance in contrast to purely inductive solutions that may require large coils that require coils to be very close (e.g., mms). Resonant inductive coupling techniques may thus allow for improved efficiency and power transfer over various distances and with a variety of inductive coil configurations.

The receiver 108 may receive power when the receiver 108 is located in an energy field 105 produced by the transmitter 104. The field 105 corresponds to a region where energy output by the transmitter 104 may be captured by a receiver 105. In some cases, the field 105 may correspond to the “near-field” of the transmitter 104 as will be further described below. The transmitter 104 may include a transmit antenna 114 for outputting an energy transmission. The receiver 108 further includes a receive antenna 118 for receiving or capturing energy from the energy transmission. The near-field may correspond to a region in which there are strong reactive fields resulting from the currents and charges in the transmit antenna 114 that minimally radiate power away from the transmit antenna 114. In some cases the near-field may correspond to a region that is within about one wavelength (or a fraction thereof) of the transmit antenna 114. The transmit and receive antennas 114 and 118 are sized according to applications and devices to be associated therewith. As described above, efficient energy transfer may occur by coupling a large portion of the energy in a field 105 of the transmit antenna 114 to a receive antenna 118 rather than propagating most of the energy in an electromagnetic wave to the far field. When positioned within the field 105, a “coupling mode” may be developed between the transmit antenna 114 and the receive antenna 118. The area around the transmit and receive antennas 114 and 118 where this coupling may occur is referred to herein as a coupling-mode region.

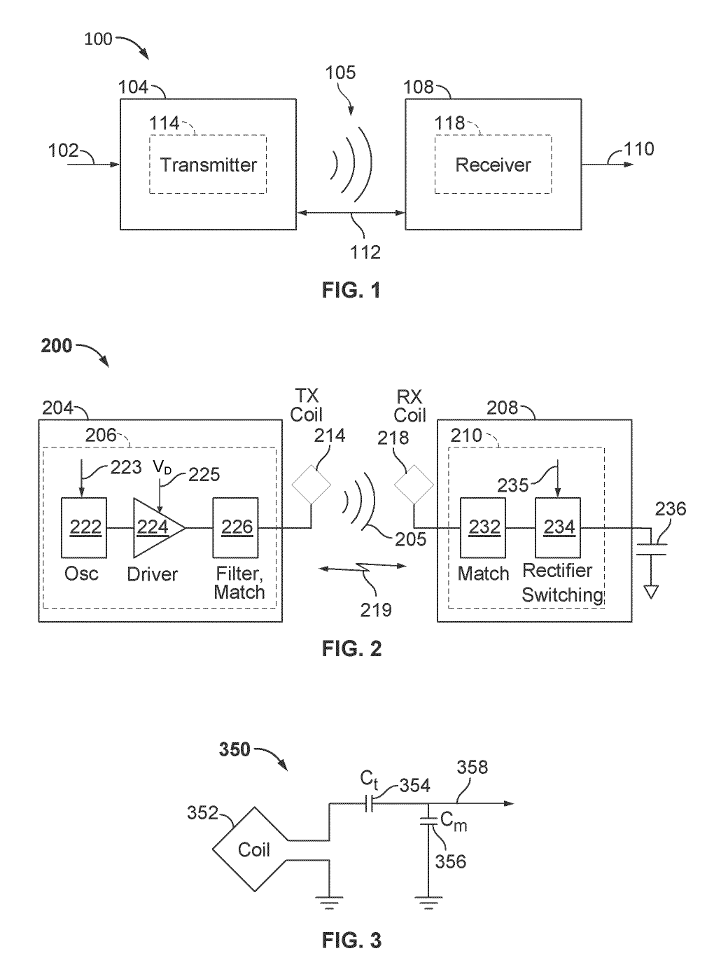

FIG. 2 is a functional block diagram of exemplary components that may be used in the wireless power transfer system 100 of FIG. 1, in accordance with various exemplary embodiments of the invention. The transmitter 204 may include transmit circuitry 206 that may include an oscillator 222, a driver circuit 224, and a filter and matching circuit 226. The oscillator 222 may be configured to generate a signal at a desired frequency, such as 468.75 KHz, 6.78 MHz or 13.56 MHz, that may be adjusted in response to a frequency control signal 223. The oscillator signal may be provided to a driver circuit 224 configured to drive the transmit antenna 214 at, for example, a resonant frequency of the transmit antenna 214. The driver circuit 224 may be a switching amplifier configured to receive a square wave from the oscillator 222 and output a sine wave. For example, the driver circuit 224 may be a class E amplifier. A filter and matching circuit 226 may be also included to filter out harmonics or other unwanted frequencies and match the impedance of the transmitter 204 to the transmit antenna 214. As a result of driving the transmit antenna 214, the transmitter 204 may wirelessly output power at a level sufficient for charging or powering an electronic device. As one example, the power provided may be for example on the order of 300 milliwatts (mW) to 5 watts (W) to power or charge different devices with different power requirements. Higher or lower power levels may also be provided.

The receiver 208 may include receive circuitry 210 that may include a matching circuit 232 and a rectifier and switching circuit 234 to generate a DC power output from an AC power input to charge a battery 236 as shown in FIG. 2 or to power a device (not shown) coupled to the receiver 208. The matching circuit 232 may be included to match the impedance of the receive circuitry 210 to the receive antenna 218. The receiver 208 and transmitter 204 may additionally communicate on a separate communication channel 219 (e.g., Bluetooth, zigbee, cellular, etc). The receiver 208 and transmitter 204 may alternatively communicate via in-band signaling using characteristics of the wireless field 206.

As described more fully below, receiver 208—which may initially have an associated load that can be selectively disabled (e.g., battery 236)—may be configured to determine whether an amount of power transmitted by transmitter 204 and received by receiver 208 is appropriate for charging a battery 236. Further, receiver 208 may be configured to enable a load (e.g., battery 236) upon determining that the amount of power is appropriate. In some embodiments, a receiver 208 may be configured to directly utilize power received from a wireless power transfer field without charging of, for example, a battery 236. For example, a communication device, such as a near-field communication (NFC) or radio-frequency identification (RFID) device may be configured to receive power from a wireless power transfer field and communicate by interacting with the wireless power transfer field and/or utilize the received power to communicate with a transmitter 204 or other devices.

FIG. 3 is a schematic diagram of a portion of transmit circuitry 206 or receive circuitry 210 of FIG. 2, including a transmit or receive antenna 352, in accordance with exemplary embodiments of the invention. As illustrated in FIG. 3, transmit or receive circuitry 350 used in exemplary embodiments including those described below may include an antenna 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna may also be referred to as a coil of a type that is configured to wirelessly output or receive power. As used herein, an antenna 352 is an example of a “power transfer component” of a type that is configured to wirelessly output and/or receive power. The antenna 352 may be configured to include an air core or a physical core such as a ferrite core (not shown). Air core loop antennas may be more tolerable to extraneous physical devices placed in the vicinity of the core. Furthermore, an air core loop antenna 352 allows the placement of other components within the core area. In addition, an air core loop may more readily enable placement of the receive antenna 218 (FIG. 2) within a plane of the transmit antenna 214 (FIG. 2) where the coupled-mode region of the transmit antenna 214 (FIG. 2) may be more powerful.

As stated, efficient transfer of energy between the transmitter 104 and receiver 108 may occur during matched or nearly matched resonance between the transmitter 104 and the receiver 108. However, even when resonance between the transmitter 104 and receiver 108 are not matched, energy may be transferred, although the efficiency may be affected. Transfer of energy occurs by coupling energy from the field 105 of the transmit antenna 114 coil to the receive antenna 118 residing in the neighborhood where this field 105 is established rather than propagating the energy from the transmit antenna 114 into free space.

The resonant frequency of the loop or magnetic antennas is based on the inductance and capacitance. Inductance may be simply the inductance created by the antenna 352, whereas, capacitance may be added to the antenna's inductance to create a resonant structure at a desired resonant frequency. As a non-limiting example, capacitor 354 and capacitor 356 may be added to the transmit or receive circuitry 350 to create a resonant circuit that selects a signal 358 at a resonant frequency. Furthermore, as the diameter of the antenna increases, the efficient energy transfer area of the near-field may increase. Accordingly, for larger diameter antennas, the size of capacitance needed to sustain resonance may decrease as the diameter or inductance of the loop increases. Other resonant circuits formed using other components are also possible. As another non-limiting example, a capacitor may be placed in parallel between the two terminals of the antenna 352. For transmit antennas, a signal 358 with a frequency that substantially corresponds to the resonant frequency of the antenna 352 may be an input to the antenna 352.

In one embodiment, the transmitter 104 may be configured to output a time varying magnetic field with a frequency corresponding to the resonant frequency of the transmit antenna 114. When the receiver is within the field 105, the time varying magnetic field may induce a current in the receive antenna 118. As described above, if the receive antenna 118 is configured to be resonant at the frequency of the transmit antenna 114, energy may be efficiently transferred. The AC signal induced in the receive antenna 118 may be rectified as described above to produce a DC signal that may be provided to charge or to power a load.

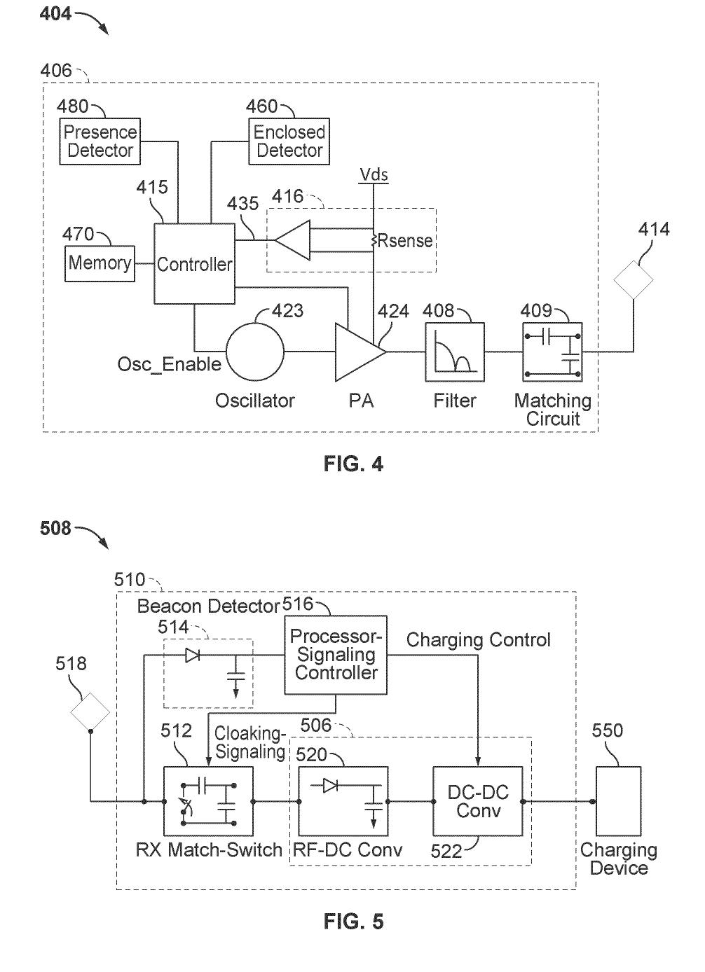

FIG. 4 is a functional block diagram of a transmitter 404 that may be used in the wireless power transfer system of FIG. 1, in accordance with exemplary embodiments of the invention. The transmitter 404 may include transmit circuitry 406 and a transmit antenna 414. The transmit antenna 414 may be the antenna 352 as shown in FIG. 3. Transmit circuitry 406 may provide RF power to the transmit antenna 414 by providing an oscillating signal resulting in generation of energy (e.g., magnetic flux) about the transmit antenna 414. Transmitter 404 may operate at any suitable frequency. By way of example, transmitter 404 may operate at the 6.78 MHz ISM band.

Transmit circuitry 406 may include a fixed impedance matching circuit 409 for matching the impedance of the transmit circuitry 406 (e.g., 50 ohms) to the transmit antenna 414 and a low pass filter (LPF) 408 configured to reduce harmonic emissions to levels that prevent self-jamming of devices coupled to receivers 108 (FIG. 1). Other exemplary embodiments may include different filter topologies, including but not limited to, notch filters that attenuate specific frequencies while passing others and may include an adaptive impedance match, that may be varied based on measurable transmit metrics, such as output power to the antenna 414 or DC current drawn by the driver circuit 424. Transmit circuitry 406 further includes a driver circuit 424 configured to drive an RF signal as determined by an oscillator 423. The transmit circuitry 406 may be comprised of discrete devices or circuits, or alternately, may be comprised of an integrated assembly. An exemplary RF power output from transmit antenna 414 may be on the order of 2.5 watts.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as processor 415. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit antenna 414. By way of example, a load sensing circuit 416 monitors the current flowing to the driver circuit 424 that may be affected by the presence or absence of active receivers in the vicinity of the field generated by transmit antenna 414 as will be further described below. Detection of changes to the loading on the driver circuit 424 are monitored by controller 415 for use in determining whether to enable the oscillator 423 for transmitting energy and to communicate with an active receiver. As described more fully below, a current measured at the driver circuit 424 may be used to determine whether an invalid device is positioned within a wireless power transfer region of the transmitter 404.

The transmit antenna 414 may be implemented with a Litz wire or as an antenna strip with the thickness, width and metal type selected to keep resistive losses low. In one implementation, the transmit antenna 414 may generally be configured for association with a larger structure such as a table, mat, lamp or other less portable configuration. Accordingly, the transmit antenna 414 generally may not need “turns” in order to be of a practical dimension. An exemplary implementation of a transmit antenna 414 may be “electrically small” (i.e., fraction of the wavelength) and tuned to resonate at lower usable frequencies by using capacitors to define the resonant frequency.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert conventional AC power present in a building, a DC-DC converter (not shown) to convert a conventional DC power source to a voltage suitable for the transmitter 404, or directly from a conventional DC power source (not shown).

As a non-limiting example, the presence detector 480 may be a motion detector utilized to sense the initial presence of a device to be charged that is inserted into the coverage area of the transmitter 404. After detection, the transmitter 404 may be turned on and the RF power received by the device may be used to toggle a switch on the Rx device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some exemplary embodiments, there may be regulations limiting the amount of power that a transmit antenna 414 may transmit at a specific frequency. In some cases, these regulations are meant to protect humans from electromagnetic radiation. However, there may be environments where a transmit antenna 414 is placed in areas not occupied by humans, or occupied infrequently by humans, such as, for example, garages, factory floors, shops, and the like. If these environments are free from humans, it may be permissible to increase the power output of the transmit antenna 414 above the normal power restrictions of such regulations. In other words, the controller 415 may adjust the power output of the transmit antenna 414 to a regulatory level or lower in response to human presence and adjust the power output of the transmit antenna 414 to a level above the regulatory level when a human is outside a regulatory distance from the electromagnetic field of the transmit antenna 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 404 does not remain on indefinitely may be used. In this case, the transmitter 404 may be programmed to shut off after a user-determined amount of time. This feature prevents the transmitter 404, notably the driver circuit 424, from running long after the wireless devices in its perimeter are fully charged. This event may be due to the failure of the circuit to detect, for example, the signal sent from either the repeater or the receive antenna 218 that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption that the device is initially fully discharged.

FIG. 5 is a functional block diagram of a receiver 508 that may be used in the wireless power transfer system of FIG. 1, in accordance with exemplary embodiments of the invention. The receiver 508 includes receive circuitry 510 that may include a receive antenna 518. Receiver 508 further couples to device 550 for providing received power thereto. It should be noted that receiver 508 is illustrated as being external to device 550 but may be integrated into device 550. Energy may be propagated wirelessly to receive antenna 518 and then coupled through the rest of the receive circuitry 510 to device 550. By way of example, the charging device may include devices such as mobile phones, portable music players, laptop computers, tablet computers, computer peripheral devices, communication devices (e.g., Bluetooth devices), digital cameras, hearing aids (and other medical devices), and the like.

Receive antenna 518 may be tuned to resonate at the same frequency, or within the same specified range of frequencies, as transmit antenna 414 (FIG. 4). Receive antenna 518 may be similarly dimensioned with transmit antenna 414 or may be differently sized based upon the dimensions of the associated device 550. By way of example, device 550 may be a portable electronic device having smaller diameter or length dimensions than the diameter or length of transmit antenna 414. In such an example, receive antenna 518 may be implemented as a multi-turn coil in order to reduce the capacitance value of a tuning capacitor (not shown) and increase the receive coil's impedance. By way of example, receive antenna 518 may be placed around the substantial circumference of device 550 in order to maximize the antenna diameter and reduce the number of loop turns (i.e., windings) of the receive antenna 518 and the inter-winding capacitance.

Receive circuitry 510 may provide an impedance match to the receive antenna 518. Receive circuitry 510 includes power conversion circuitry 506 for converting a received RF energy source into charging power for use by the device 550. Power conversion circuitry 506 includes an RF-to-DC converter 520 and may also in include a DC-to-DC converter 522. RF-to-DC converter 520 rectifies the RF energy signal received at receive antenna 518 into a non-alternating power with an output voltage represented by V_{rect}. The DC-to-DC converter 522 (or other power regulator) converts the rectified RF energy signal into an energy potential (e.g., voltage) that is compatible with device 550 with an output voltage and output current represented by Vₒᵤₜ and Tₒᵤₜ. Various RF-to-DC converters are contemplated, including partial and full rectifiers, regulators, bridges, doublers, as well as linear and switching converters.

Receive circuitry 510 may further include switching circuitry 512 for connecting receive antenna 518 to the power conversion circuitry 506 or alternatively for disconnecting the power conversion circuitry 506. Disconnecting receive antenna 518 from power conversion circuitry 506 not only suspends charging of device 550, but also changes the “load” as “seen” by the transmitter 404 (FIG. 4).

As disclosed above, transmitter 404 includes load sensing circuit 416 that may detect fluctuations in the bias current provided to transmitter driver circuit 424. Accordingly, transmitter 404 has a mechanism for determining when receivers are present in the transmitter's near-field.

When multiple receivers 508 are present in a transmitter's near-field, it may be desirable to time-multiplex the loading and unloading of one or more receivers to enable other receivers to more efficiently couple to the transmitter. A receiver 508 may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 may provide a communication mechanism from receiver 508 to transmitter 404 as is explained more fully below. Additionally, a protocol may be associated with the switching that enables the sending of a message from receiver 508 to transmitter 404. By way of example, a switching speed may be on the order of 100 μsec.

In an exemplary embodiment, communication between the transmitter 404 and the receiver 508 refers to a device sensing and charging control mechanism, rather than conventional two-way communication (i.e., in band signaling using the coupling field). In other words, the transmitter 404 may use on/off keying of the transmitted signal to adjust whether energy is available in the near-field. The receiver 508 may interpret these changes in energy as a message from the transmitter 404. From the receiver side, the receiver 508 may use tuning and de-tuning of the receive antenna 518 to adjust how much power is being accepted from the field. In some cases, the tuning and de-tuning may be accomplished via the switching circuitry 512. The transmitter 404 may detect this difference in power used from the field and interpret these changes as a message from the receiver 508. It is noted that other forms of modulation of the transmit power and the load behavior may be utilized.

Receive circuitry 510 may further include signaling detector and beacon circuitry 514 used to identify received energy fluctuations that may correspond to informational signaling from the transmitter 404 to the receiver 508. Furthermore, signaling and beacon circuitry 514 may also be used to detect the transmission of a reduced RF signal energy (i.e., a beacon signal) and to rectify the reduced RF signal energy into a nominal power for awakening either un-powered or power-depleted circuits within receive circuitry 510 in order to configure receive circuitry 510 for wireless charging.

Receive circuitry 510 further includes processor 516 for coordinating the processes of receiver 508 described herein including the control of switching circuitry 512 described herein. Cloaking of receiver 508 may also occur upon the occurrence of other events including detection of an external wired charging source (e.g., wall/USB power) providing charging power to device 550. Processor 516, in addition to controlling the cloaking of the receiver, may also monitor beacon circuitry 514 to determine a beacon state and extract messages sent from the transmitter 404. Processor 516 may also adjust the DC-to-DC converter 522 for improved performance.

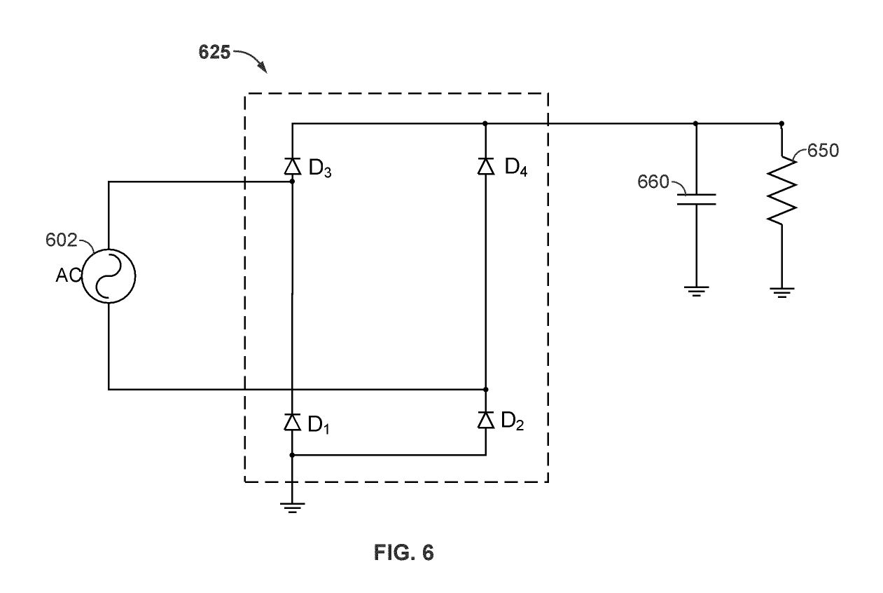

FIG. 6 is a schematic diagram of an full bridge rectifier circuit 625. For example, the RF-to-DC converter 520 of the receive circuitry 510 (FIG. 5) may include a rectifier circuit such as the full bridge rectifier circuit 625. The rectifier circuit 625 includes four diodes D1, D2, D3, and D4 electrically connected to an AC output source 602. For example, the AC output source 602 may be configured as an antenna that generates an alternating current in response to an alternating magnetic field as described above. The diodes D1, D2, D3, and D4 are electrically connected to the AC output source 602 such that direct current (DC) is provided at an output of the rectifier circuit 625 regardless of the polarity of the voltage. The output of the rectifier circuit 625 is electrically coupled to a load 650. More particularly, when the voltage provided by the AC output source 602 is positive relative to ground, diodes D3 and D2 conduct such that current flows through the load 650 to ground. When the voltage provided by the AC output source 602 is negative relative to ground, diodes D4 and D1 conduct such that current flows through the load 650 to ground. As such, direct current is provided to the load 650. In addition a smoothing capacitor 660 may be electrically coupled to the load 650. The smoothing capacitor 660 smoothes the output of the diodes D1, D2, D3, and D4 to provide a constant DC to the load 650.

In some cases, due to inefficient operation and other undesirable characteristics of the diodes D1, D2, D3, and D4, at least a portion of the diodes D1, D2, D3, and D4 may be replaced with switches to form a synchronous rectifier. In this case, the switches are controlled such that they operate in a similar manner as the diodes D1, D2, D3, and D4 as described above such that DC is provided at the output in response to a time varying input signal.

When using a synchronous rectifier, the operation of the switches is timed and controlled to match the input signal. To reduce complexity, particularly as the frequency of the input signal increases, a self-driven synchronous rectifier may be provided. In this case, the control signals for operating the switches are provided by the time-varying input signal to the rectifier circuit. For example, if transistors such as MOSFETs are used, the gates of the MOSFETS are electrically coupled to the AC output source 602. When a self-driven synchronous rectifier operates at higher frequencies (e.g., such as the 6.78 MHz frequency used for wireless power transmission as described above according to one embodiment), the transistors may have high losses and have non-trivial amounts of capacitance with the gate drive. As such, certain aspects of embodiments described herein provide for an improved self-driven synchronous rectifier circuit to reduce losses and provide for more efficient operation. According to some aspects, embodiments for a self-driven synchronous rectifier circuit may provide for particular efficiency enhancements for use in a wireless power receiver with an operating frequency as described above (e.g., at 6.78 MHz).

In accordance with an embodiment, the transistors of a self-driven synchronous rectifier circuit may be selected to have properties that may increase efficiency. For example, in accordance with an embodiment, transistors with lower capacitance are selected. For example, gallium nitride field effect transistors (GANFETs) may be used. In some aspects silicon carbide may be used.

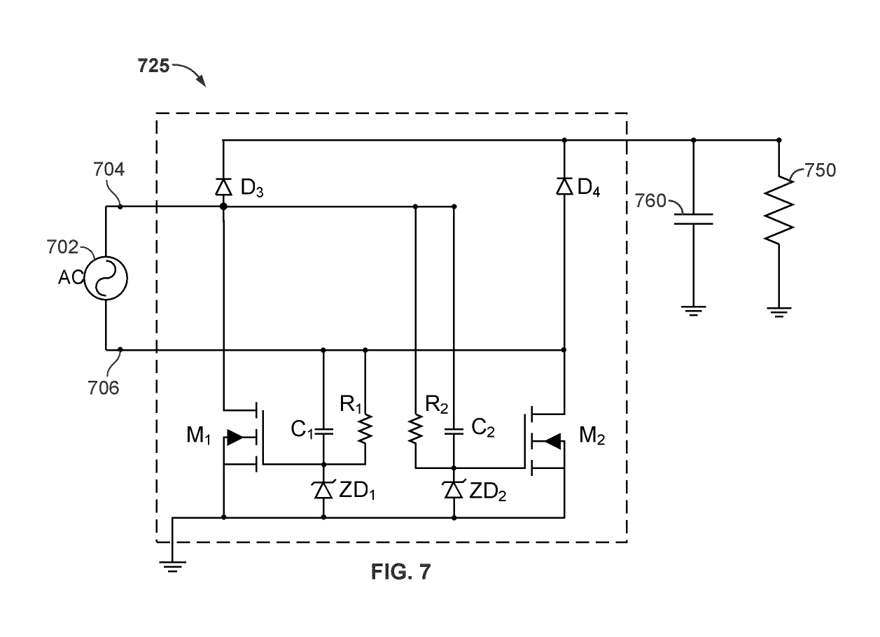

FIG. 7 is a schematic diagram of an self-driven synchronous rectifier circuit 725. The rectifier circuit 725 includes diodes D3 and D4 as similarly described above with reference to FIG. 6. In place of diodes D1 and D2 of FIG. 6, transistors M1 and M2 are included. Transistor M1 is coupled between a first side (shown by node 704) of the AC output source 702 and ground. The gate of M1 is coupled via a filter circuit including R1 and C1 to the second side (shown by node 706) side of AC output source 702. As such, as the voltage difference between the second side 706 and ground rises above the gate threshold voltage, current may conduct between ground and the first side 704 of the AC output source. As a result, current flows through D4 and through the load 750. Similarly, transistor M2 is coupled between the second side 706 of the AC output source 702 and ground. The gate of transistor M2 is coupled to the first side 704 of the AC output source 702 and ground via a filter circuit including C2 and R2. As the voltage difference between the first side 704 and ground rises above the gate threshold voltage, the transistor M2 is activated such that current may conduct between ground and the second side 706 of the AC output source 702. As a result, current may flow through D3 and through the load 750. In this way, the transistors M1 and M2 are driven using the AC output source 702 and DC is provided to the load 750.

As described above, transistors M1 and M2 may be selected to increase efficiency of the self-driven synchronous rectifier circuit 725 described with reference to FIG. 7. For examples, transistors M1 and M2 may be selected to have lower gate drive requirements as compared to other types of transistors. Furthermore, transistors M1 and M2 may be selected to have lower capacitance. For example, transistors M1 and M2 may be GANFETs as described above. However, in some cases, transistors M1 and M2 may have certain limitations on the gate voltage. For example, it may be difficult to turn on M1 and M2 under low voltage conditions or high voltages may damage M1 and M2 during high voltage conditions. As a non-limiting example, the voltage applied to the gate of transistors M1 and M2 may need to be substantially 4 V to cause current to conduct between the drain and the source, while voltages above 6 V applied to the gate may damage the transistors M1 and M2. Zener diodes ZD1 and ZD2 may be respectively coupled between the gates of M1 and M2 and ground such that once the voltage on the gate is above the thresholds of the zener diodes (e.g., zener clamps), current conducts between ground and the zener diodes thus limiting the voltage applied to the gates of M1 and M2. However, in some conditions, the zener clamps ZD1 and ZD2 may waste significant power and add undesirable capacitance to the rectifier circuit 725. As such, using zener clamps may fail to increase the efficiency when using, for example, GANFETs for transistors M1 and M2.

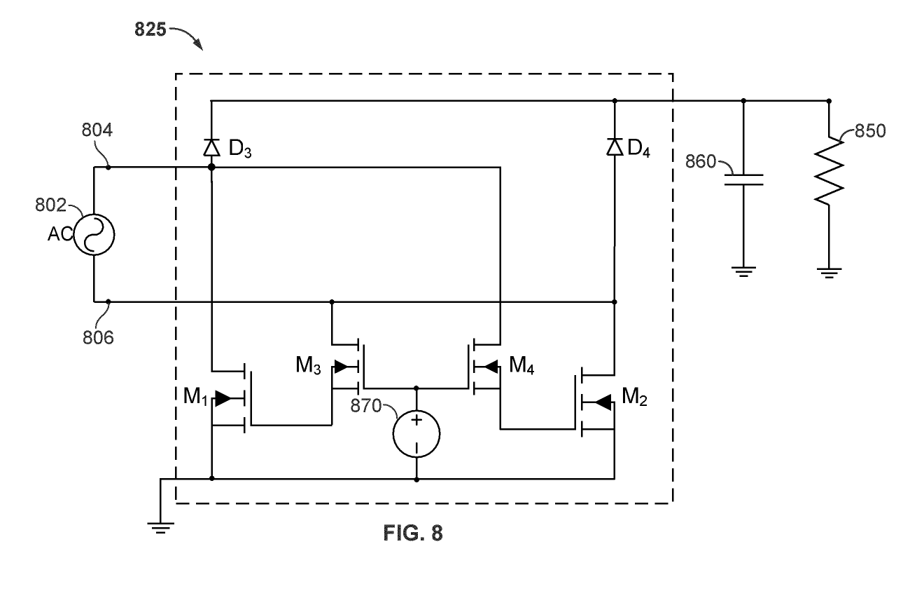

FIG. 8 is a schematic diagram of an exemplary self-driven synchronous rectifier circuit 825, in accordance with exemplary embodiments of the invention. In at least some aspects, the self-driven synchronous rectifier circuit 825 may overcome at least some of the disadvantages of using zener diodes ZD1 and ZD2 as described above with reference to FIG. 7. The rectifier circuit 825 includes transistors M3 and M4. Transistor M3 is coupled between the second side 806 of the AC output source 802 and the gate of transistor M1. As described above, transistors M1 and M2 may have a narrow voltage operating range (e.g., M1 and M2 may be GANFETs which may require a gate-source voltage of, for example, over four volts to cause the drain-to-source channel to conduct while being damaged as a result of voltages over, for example, six volts). The gate of M3 is coupled to a voltage source 870. Likewise, transistor M4 is coupled between the first side 804 of the AC output source 802 and the gate of transistor M2. The gate of M4 is coupled to the voltage source 870. The voltage source may be at a level that is higher than the desired voltage to be applied to the gate of M1 and M2. For example, the voltage source 870 may be at least the turn-on threshold voltages of transistors M3 and M4 added to the desired voltage to be applied to the gate of M1 and M2.

The transistors M3 and M4 are configured to limit the voltage into the gate of the transistors M1 and M2. For example, the transistors M3 and M4 may be provided to limit the voltages applied into the gates of M1 and M2 such that the applied voltages are within the gate voltage requirements of the transistors M1 and M2 to operate without causing damage. For example, the desired voltage for the gates M1 and M2 may be 5 volts, while the voltage source 870 is something similar to 6.5 volts. Once the voltage into the gate of transistor M2 reaches 5 volts, M4 acts as an open circuit, preventing further increases in gate voltage to the transistor M2 (and likewise for M1 and M3). As the voltage is limited by an open circuit rather than a shunt such as a zener diode ZD1, power loss and capacitive loading is decreased. Furthermore, little significant power is lost as compared to the shunt as shown. Tying the gates of the transistors M3 and M4 to a voltage source, rather than, for example, ground allows for more precise control of the transistors M1 and M2. This more precise control is advantageous as the transistors M1 and M2 may require any applied gate voltage to be within a narrow range in order for the transistors to be operational. If the applied gate voltage is too low, current may not conduct between the drain and the source; if the applied gate voltage is too high, the transistors M1 and M2 may be damaged.

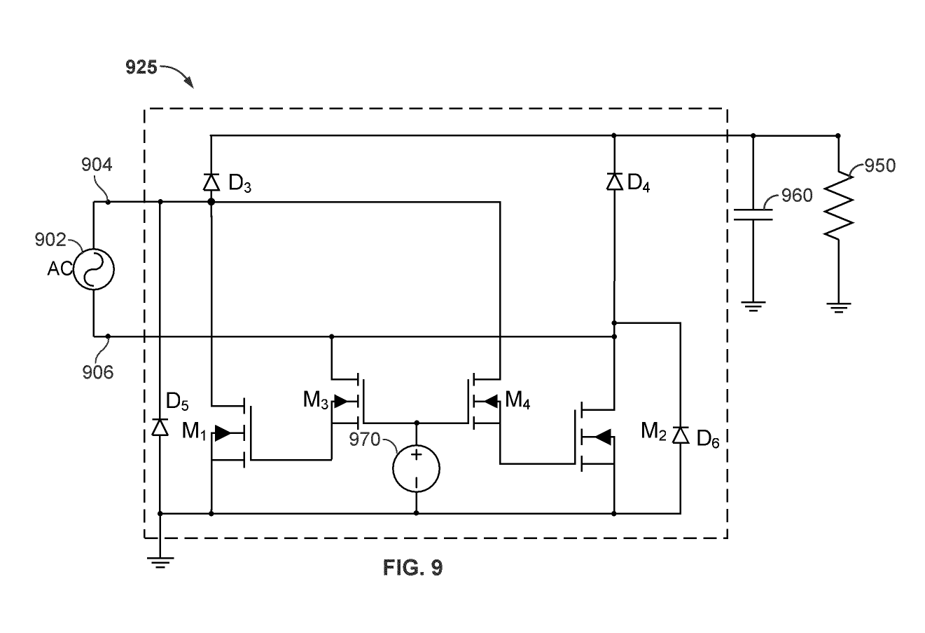

FIG. 9 is yet another schematic diagram of an exemplary self-driven synchronous rectifier circuit 925, in accordance with an exemplary embodiment of the invention. FIG. 9 shows optional diodes D5 and D6 that may be coupled in parallel with transistors M1 and M2, respectively.

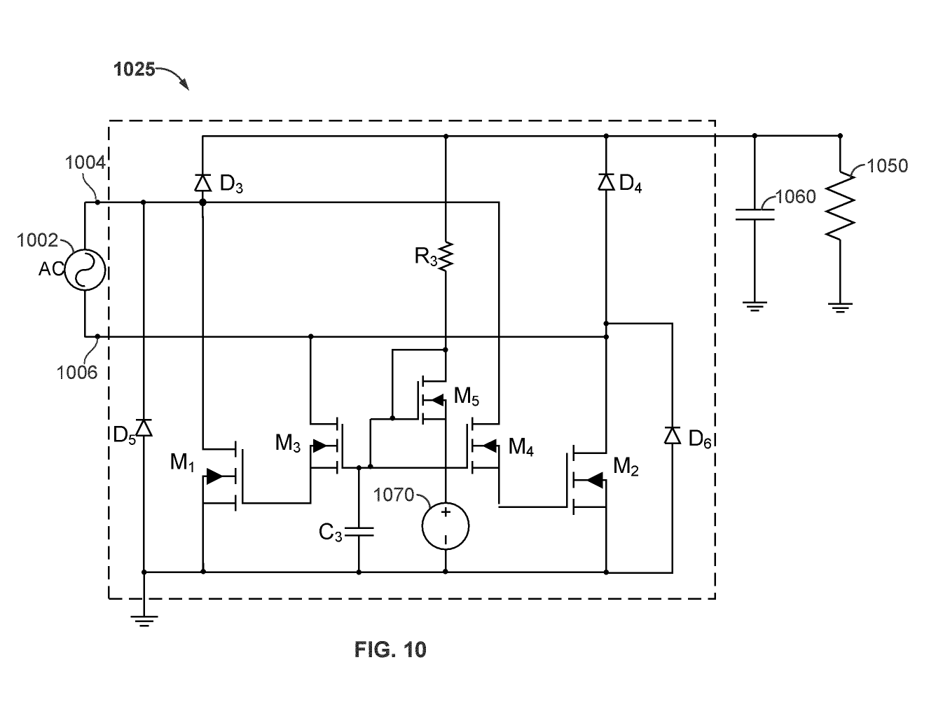

FIG. 10 is yet another schematic diagram of an exemplary self-driven synchronous rectifier circuit 1025, in accordance with an exemplary embodiment of the invention. FIG. 10 shows the elements described with respect to FIG. 9, and further includes a transistor M5. Transistor M5 is coupled between a node between diodes D3 and D4 and a voltage source 1070. The gate of transistor M5 is coupled to the gates of transistors M3 and M4.

Transistor M5 is biased such that the drain-to-source voltage is substantially equal to the gate-to-source threshold voltage. The voltage of the gates of transistors M3, M4, and M5 is substantially equal to the sum of the voltage provided by the voltage source 1070 and the gate-to-source threshold voltage of M5. M3 and M4 are substantially of the same type as M5 and therefore may have substantially the same gate-to-source threshold voltage and temperature characteristics. Using five volts as an example (e.g., when the voltage source 1070 is five volts), when the source of transistor M3 is less than five volts, M3 conducts due to the fact that the voltage gate-to-source is greater than the threshold voltage. As the drain of transistor M3 rises past five volts, transistor M3 turns off, leaving the gate of transistor M1 at five volts. In an embodiment, a resistor may be added from the gate to source of transistor M1 to compensate for leakage of transistor M3, however, this may not be necessary as the high frequency and the capacitance from gate-to-source of M1 may prevent overshoot on the gate. On the falling edge of the drain of M3, M3 is “forced” back into conduction through its internal body diode and by the rise of the voltage gate-to-source of M3 as the drain voltage falls, completing the cycle. As compared to FIG. 8, the use of the transistor M5 in some cases may allow for more precise regulation over the maximum gate voltage of M1 and M2.

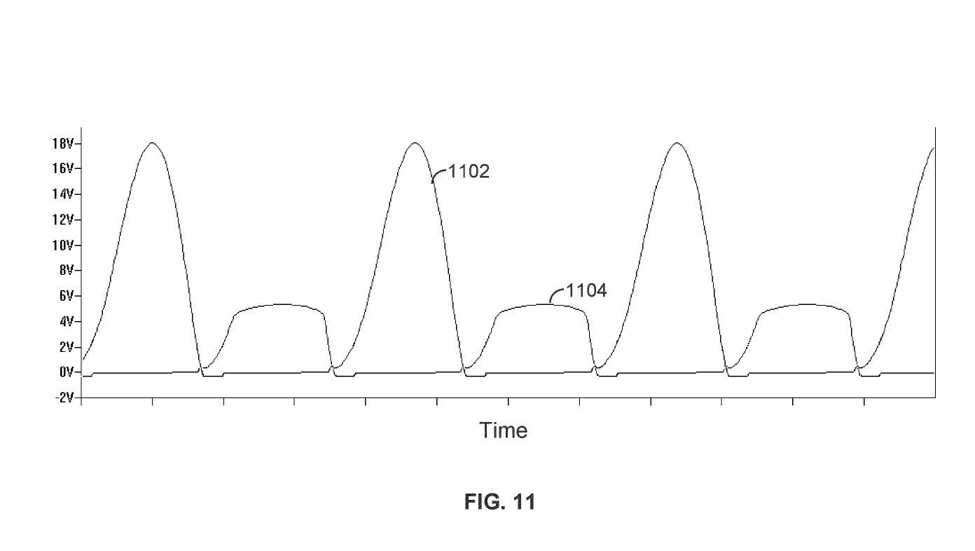

FIG. 11 is a plot showing exemplary voltage waveforms 1102 and 1104 of the self-driven synchronous rectifier circuit 1025 of FIG. 10. The waveform 1102 may correspond to a voltage that may be provided by the AC output source 1002. For example, if the AC output source 1002 comprises wireless power receiver antenna configured to generate AC via an alternating magnetic field, the range of voltages shown by the waveform 1102 may vary, for example as shown up to 18 V. As described above, if particular MOSFETs M1 and M2 are chosen to increase efficiency, voltages above a certain value (e.g., five volts) may damage the MOSFETs M1 and M2. Waveform 1104 shows an example of the voltage from the gate of transistor M1 to the ground in accordance with the rectifier circuit 1025 of FIG. 10. As shown, the voltage gate-to-source of M1 rises until the voltage waveform 1102 reaches substantially five volts. At that point the voltage waveform 1104 is maintained at substantially five volts while the waveform 1102 increases. As such, the gate-to-source voltage of transistor M1 is limited based on operation of the transistor M3.

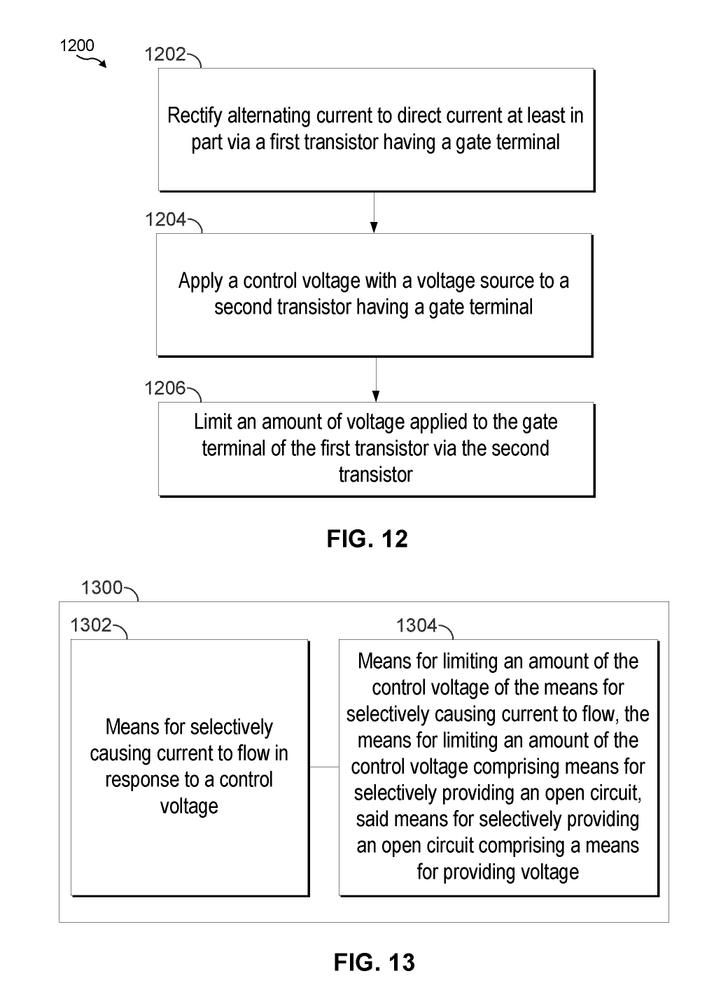

FIG. 12 is a flow chart of an exemplary method 1200 for providing direct current (DC) based at least in part on an alternating current from an AC output source, in accordance with an exemplary embodiment of the invention. At block 1202 alternating current is rectified to direct current at least in part via a first transistor having a gate terminal. At block 1204 a control voltage is applied by a voltage source to a second transistor having a gate terminal. At block 1206 an amount of voltage applied to the gate terminal of the first transistor is limited by the second transistor.

FIG. 13 is a functional block diagram of an apparatus for providing direct current (DC) based at least in part on an alternating current from an AC output source, in accordance with an exemplary embodiment of the invention. The apparatus comprises means 1302 and 1304 for the various actions discussed with respect to FIGS. 1-12.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations. For example, a means for selectively allowing current in response to a control voltage may comprise a first transistor. In addition, means for limiting an amount of the control voltage comprising means for selectively providing an open circuit may comprise a second transistor.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the invention.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A rectifier circuit for providing direct current (DC) voltage to a load based at least in part on an alternating current (AC) input from an AC output source having a first and second terminal, the circuit comprising:
a first transistor having a first terminal, a second terminal, and a control terminal;
a second transistor having a first terminal, a second terminal, and a control terminal, the second transistor configured to limit a voltage applied to the control terminal of the first transistor; and
the second terminal of the first transistor coupled to the second terminal of the AC output source, the control terminal of the first transistor coupled to the first terminal of the second transistor, the second terminal of the second transistor coupled to the first terminal of the AC output source, and the control terminal of the second transistor coupled to a voltage source.

2. The rectifier circuit of claim 1, the control terminal of the first transistor coupled to a voltage at or below a threshold operating voltage.

3. The rectifier circuit of claim 2, wherein the voltage source coupled to the control terminal of the second transistor is configured to provide a voltage at least equal to a sum of the threshold operating voltage for the control terminal of the first transistor and the turn-on threshold voltage of the second transistor.

4. The rectifier circuit of claim 2, further comprising a third transistor having a first terminal, a second terminal, and a control terminal, the first terminal of the third transistor being coupled to a voltage source configured to provide the threshold operating voltage for the control terminal of the first transistor, the control terminal of the third transistor being coupled to the control terminal of the second transistor.

5. The rectifier circuit of claim 4, wherein the third transistor is coupled between the voltage source configured to provide the threshold operating voltage for the control terminal of the first transistor and a node between a first diode and a second diode.

6. The rectifier circuit of claim 1, further comprising a diode electrically coupled between the first terminal of the AC output source and the load.

7. The rectifier circuit of claim 1, further comprising:
a third transistor having a first terminal, a second terminal, and a control terminal;
a fourth transistor having a first terminal, a second terminal, and a control terminal, wherein the fourth transistor is configured to limit a voltage applied to the control terminal of the third transistor; and
wherein the second terminal of the third transistor is coupled to the first terminal of the AC output source, the first terminal of the fourth transistor is coupled to the control terminal of the third transistor, and the second terminal of the fourth transistor is coupled to the second terminal of the AC output source.

8. The rectifier circuit of claim 1, wherein the first transistor is a gallium nitride field effect transistor (GANFET).

9. The rectifier circuit of claim 4, wherein the first transistor is a gallium nitride field effect transistor (GANFET).

10. The rectifier circuit of claim 7, wherein the third transistor is a gallium nitride field effect transistor (GANFET).

11. A method for providing direct current (DC) based at least in part on an alternating current from an AC output source, the method comprising:
rectifying the alternating current to the direct current at least in part via a first transistor having a control terminal;
applying a control voltage with a voltage source to a second transistor having a control terminal; and
limiting an amount of voltage applied to the control terminal of the first transistor via the second transistor.

12. The method of claim 11, further comprising:
turning off the second transistor such that current does not flow between the second and first terminals of the second transistor in response to a voltage from the AC output source being above a threshold operating voltage for the control terminal of the first transistor such that voltage applied to the control terminal of the first transistor is maintained at or below the threshold operating voltage.

13. The method of claim 12, further comprising:
applying a control voltage with the voltage source to the control terminal of the second transistor, wherein the control voltage provided by the voltage source is at least equal to a sum of the threshold operating voltage for the control terminal of the first transistor and the turn-on threshold voltage of the second transistor.

14. The method of claim 11, further comprising:
limiting an amount of voltage applied to the control terminal of the first transistor via a third transistor, wherein at least one terminal of the third transistor is coupled to at least one terminal of the second transistor.

15. The method of claim 12, wherein the control terminal of the third transistor is coupled to the control terminal of the second transistor.

16. An apparatus for providing direct current (DC) based at least in part on an alternating current from an AC output source, the apparatus comprising:
means for selectively causing current to flow in response to a control voltage; and
means for limiting an amount of the control voltage of the means for selectively causing current to flow, the means for limiting an amount of the control voltage comprising means for selectively providing an open circuit and a means for providing voltage.

17. The apparatus of claim 16, wherein the means for selectively causing current to flow in response to a control voltage further comprises a gallium nitride field effect transistor (GANFET).

18. The apparatus of claim 16, wherein the means for selectively providing an open circuit comprises a first transistor.

19. The apparatus of claim 18, wherein the means for selectively providing an open circuit further comprises a second transistor that is at least coupled to the means for providing voltage and the first transistor.
